(19) United States
(12) Patent Application Publication
(10) Pub. No.: US 2007/0195781 A1
(43) Pub. Date: Aug. 23, 2007

(54) Equipment managing device, equipment searching program, and recording medium

(76) Inventor: Tsutomu Yuki, Tokyo (JP)

Correspondence Address: DICKSTEIN SHAPIRO LLP, 1825 EYE STREET NW, Washington, DC, 20006-5403, US

(21) Appl. No.: 11/655,120

(22) Filed: Jan. 19, 2007

(30) Foreign Application Priority Data
Feb. 17, 2006 (JP) 2006-041016

(51) Int. Cl. H04L 12/56

(52) U.S. Cl. 370/392; 370/401

(57) ABSTRACT

An equipment managing device includes a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part; an address generating part configured to generate a subnet address of a network different from at least the equipment managing device; and a searching part configured to search for equipment connecting to the network different from at least the equipment managing device.

### BACKGROUND OF THE INVENTION

1. Field of the Invention

The present invention generally relates to equipment managing devices, equipment searching programs, and recording media, and more specifically, to an equipment managing device configured to manage equipment connected to a network, an equipment searching program, and a recording medium.

2. Description of the Related Art

Various network equipment items such as a printer, copier, facsimile, router, and a PC (Personal Computer) are connected to a network of a company or the like. Operational status or the like of such equipment can be monitored from a remote PC (Personal Computer) or the like by communications using a protocol such as SNMP (Simple Network Management Protocol).

Since addition or deletion of the equipment to or from the network is implemented with relatively high frequency, it is convenient to realize searching for the equipment that is a subject of monitoring at a monitoring side (PC or the like).

Because of this, conventionally, the equipment is searched for by the methods discussed below. See Japanese Laid-Open Patent Application No. 2000-76033.

A first method is searching for the equipment by issuing a broadcast wherein a broadcast address (for example, 255.255.255.255) of TCP/IP is used. According to this method, it is possible to search for the equipment existing on the same network as the PC or the like at the monitoring side.

A second method is searching for the equipment by issuing a broadcast wherein a broadcast address designating a subnet address of TCP/IP, namely a direct broadcast address (for example, 111.222.111.255) is used. According to this method, it is possible to search for the equipment existing on a different network from the monitoring side.

A third method is searching for the equipment by querying each IP address in a searching area designated in advance then searching corresponding to reaction to the query.

However, in the first method, equipment existing on a different network from the monitoring side cannot be searched for. Furthermore, in the second method or the third method, it is necessary for a user to input the searching area of the IP address or the subnet address that are searching subjects and therefore a heavy workload is forced on the user.

### SUMMARY OF THE INVENTION

Accordingly, embodiments of the present invention may provide a novel and useful equipment managing device, equipment searching program, and recording medium solving one or more of the problems discussed above.

More specifically, the embodiments of the present invention may provide an equipment managing device, an equipment searching program, and a recording medium whereby equipment on a different network can be searched for while the workload of a user is reduced.

One aspect of the present invention may be to provide an equipment managing device configured to manage equipment connected to a network, including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item; an address generating part configured to generate a subnet address of a network different from at least the equipment managing device, based on gathering the IP addresses obtained by the second address obtaining part; and a searching part configured to search for equipment connecting to the network different from at least the equipment managing device, based on the subnet address generated by the address generating part.

Another aspect of the present invention may be to provide an equipment managing device configured to manage equipment connected to a network, including: an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item; an address information generating part configured to generate address information of a network different from at least the equipment managing device, based on gathering the IP addresses obtained by the address obtaining part; and a searching part configured to search for equipment connecting to the network different from at least the equipment managing device, based on the address information generated by the address information generating part.

Other aspect of the present invention may be to provide an equipment managing device configured to manage equipment connected to a network, including an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item; an address generating part configured to generate a subnet address of a network different from at least the equipment managing device, based on gathering the IP addresses obtained by the address obtaining part; and a searching part configured to search for equipment connecting to the network different from at least the equipment managing device, based on the subnet address generated by the address generating part.

According to the above-mentioned equipment managing device, it is possible to search for equipment on the different network while the workload of the user is reduced.

Other aspect of the present invention may be to provide an equipment searching program configured to make a computer function as each of parts of an equipment managing device, the equipment managing device including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address-of the other equipment item being held by the corresponding equipment item searched for by the first address obtaining part for communicating with the other equipment item; an address generating part configured to generate a subnet address of a network different from at least the equipment managing device, based on gathering the IP addresses obtained by the second address obtaining part; and a searching part configured to search for equipment connecting to the network different from at least the equipment managing device, based on the subnet address generated by the address generating part.

Other aspect of the present invention may be to provide a computer readable recording medium including an equipment searching program, the equipment searching program being configured to make a computer function as each of parts of an equipment managing device, the equipment managing device including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item; an address generating part configured to generate a subnet address of a network different from at least the equipment managing device, based on gathering the IP addresses obtained by the second address obtaining part; and a searching part configured to search for equipment connecting to the network different from at least the equipment managing device, based on the subnet address generated by the address generating part.

Thus, according to the above-mentioned present invention, it is possible to provide an equipment managing device, an equipment searching program, and a recording medium whereby equipment on a different network can be searched for while the workload of a user is reduced.

Other objects, features, and advantages of the present invention will be come more apparent from the following detailed description when read in conjunction with the accompanying drawings.

### BRIEF DESCRIPTION OF THE DRAWINGS

FIG. 1 is a view showing a network structural example of an equipment managing system of an embodiment of the present invention;

FIG. 2 is a block diagram showing a hardware structural example of an equipment managing device of the embodiment of the present invention;

FIG. 3 is a block diagram showing a function structural example of the equipment managing device of the embodiment of the present invention;

FIG. 4 is a sequence diagram for explaining process steps of an equipment searching process of a first embodiment of the present invention;

FIG. 5 is a sequence diagram for explaining process steps of an equipment searching process of a second embodiment of the present invention;

FIG. 6 is a sequence diagram for explaining process steps of an equipment searching process of a third embodiment of the present invention; and

FIG. 7 is a sequence diagram for explaining process steps of an equipment searching process of a fourth embodiment of the present invention.

### DETAILED DESCRIPTION OF THE PREFERRED EMBODIMENTS

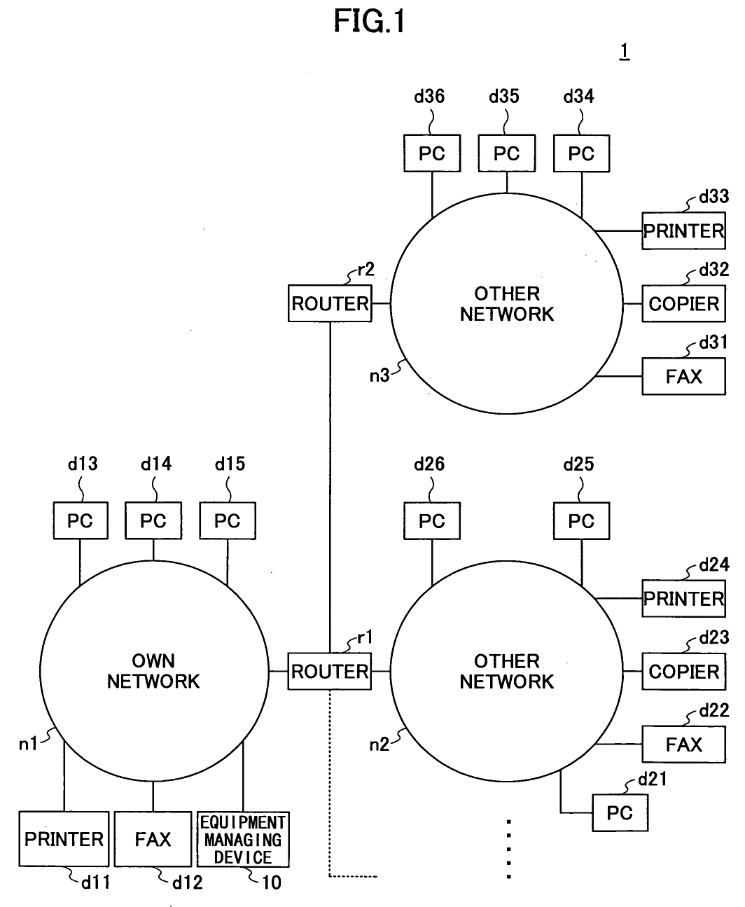

A description is given below with reference to the FIG. 1 through FIG. 7 of embodiments of the present invention.

FIG. 1 is a view showing a network structural example of an equipment managing system of an embodiment of the present invention.

An equipment managing system shown in FIG. 1 is formed by networks n1, n2, and n3 such as plural LANs (Local Area Networks), connected by routers r1 or r2. Various network equipment items or peripheral devices (routers r1 and r2, a printer, a facsimile, a copier or PC (Personal Computer)) are connected to each of the networks. Equipment items d11 through d15 are connected to the network n1, equipment items d21 through d26 are connected to the network n2, and equipment items d31 through d36 are connected to the network n3.

In an example shown in FIG. 1, an equipment managing device 10 is connected to the network n1. The equipment managing device 10 monitors or manages various equipment items.

In this embodiment, the equipment managing device 10 obtains management information (MIB information) stated in an MIB (Management Information Base) II by communicating with each of the equipment items by using SNMP (Simple Network Management Protocol). In other words, the equipment managing device 10 functions as a manger and each of the equipment items functions as an agent in SNMP communications. It should be noted that a protocol and others of the embodiment of the present invention are not limited to the above-mentioned ones.

In the example shown in FIG. 1, for convenience of explanation, three networks having different subnet addresses are shown; the equipment managing system 1 may be formed by more networks. Alternatively, the equipment managing system 1 may be formed by two or less networks. In addition, plural equipment managing devices 10 may be connected to the network.

In the embodiment of the present invention, a network n1 where the equipment managing device 10 is connected is called an “own network n1” and other networks n2 and n3 are called “other networks”.

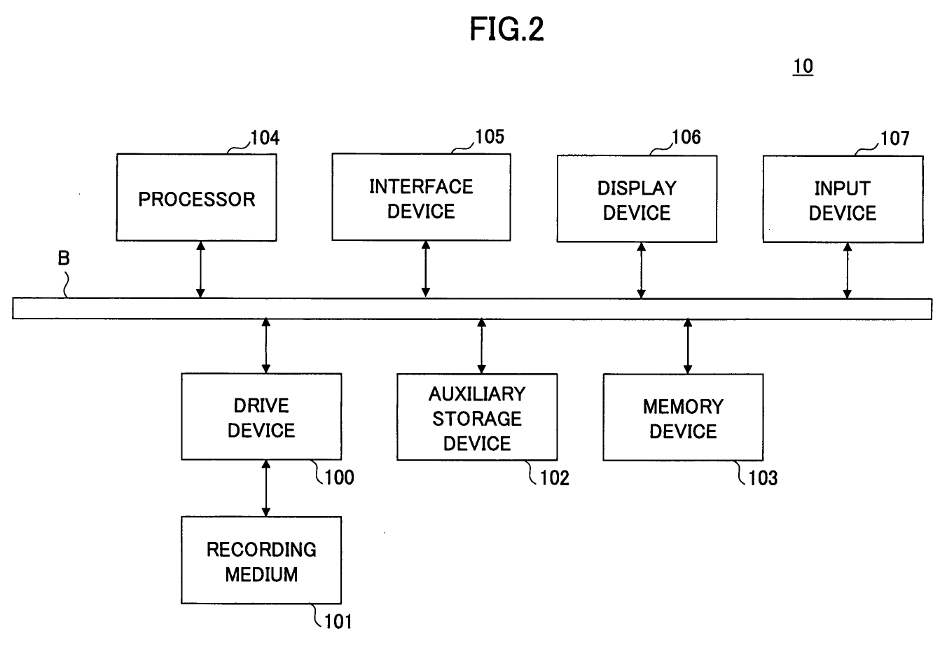

FIG. 2 is a block diagram showing a hardware structural example of an equipment managing device of the embodiment of the present invention.

The equipment managing device 10 shown in FIG. 2 includes a drive device 100, a secondary storage device 102, a memory device 103, a processor 104, an interface device 105, a display device 106, an input device 107, and others, which are connected to each other by bus B.

A program implementing a process in the equipment managing device 10 is provided by a recording medium 101 such as a CD-ROM.

When the recording medium 101 where the program is stored is loaded in the drive device 100, the program is installed from the recording medium 101 to the secondary storage device 102 via the drive device 100. The secondary storage device 102 stores the installed program and stores various data necessary for the processes of the program.

The memory device 103 reads the program from the secondary storage device 102 and stores it when receiving instruction on starting the program.

The processor 104 follows the program stored in the memory device 103 and implements functions of the equipment managing device 10. The interface device 105 is used as an interface for, such as a LAN card for connecting to the network n1 shown in FIG. 1.

The display device 106 displays a GUI (Graphical User Interface) as directed by the program. The input device 107 is formed by a keyboard, mouse, or the like and is used for inputting various operational instructions.

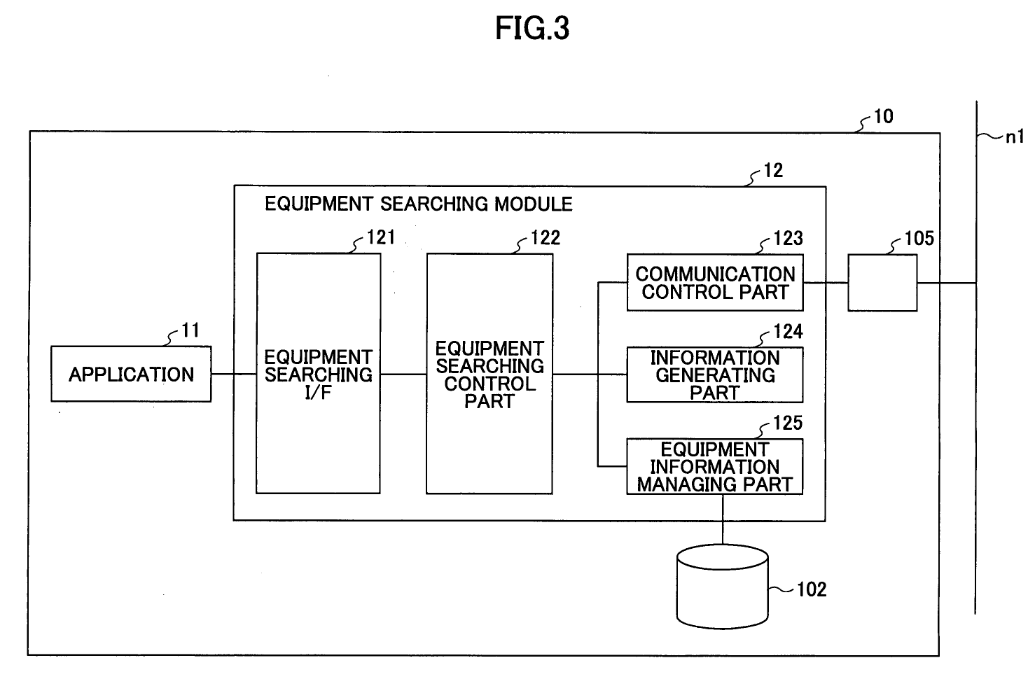

FIG. 3 is a block diagram showing a function structural example of the equipment managing device of the embodiment of the present invention.

As shown in FIG. 3, the equipment managing device 10 includes an application 11, an equipment searching module 12, and others.

The application 11 searches for various equipment items on the network by using the equipment searching module 12 and makes the display device 106 display information of the searched for equipment by GUI (Graphical User Interface)-.

The equipment searching module 12 includes an equipment searching I/F (interface) 121, an equipment searching control part 122, a communication control part 123, an information generating part 124, an equipment information managing part 125, and others.

The equipment searching I/F 121 (for example, functional interface) is an interface for using the equipment searching module 12.

The equipment searching control part 122 controls the communication control part 123, the information generating part 124, and the equipment information managing part 123 in a unified manner so as to control an equipment searching process.

The communication control part 123 implements communication control with the equipment via the interface device 105. For example, by communications of the communication control part 123, an IP address, a MAC address, or the like (hereinafter “equipment information”) of each of the equipment items is obtained.

The equipment information managing part 125 stores obtained equipment information or the like in a recoding medium such as the secondary storage device 102 and manages it.

The information generating part 124 automatically generates information for implementing subnet searching or area-designated searching based on the IP address of each of the equipment items managed by the equipment information managing part 125.

Here, subnet searching means searching for the machine by using the broadcast (direct broadcast) identifying the subnet address. By subnet searching, the equipment managing device 10 can search not only for the equipment connected to the own network n1 but also the equipment connected to other network.

The direct broadcast address may be an address needed in order to issue the direct broadcast. Therefore, the information for implementing the subnet searching is the direct broadcast address.

On the other hand, the area-designated searching means querying every IP address of the designated area and searching for the equipment based on the responses to the query. Accordingly, the information for implementing the area-designated searching corresponds to address area information that is information indicating the area of the IP address.

Next, process steps of the equipment managing device 10 are discussed.

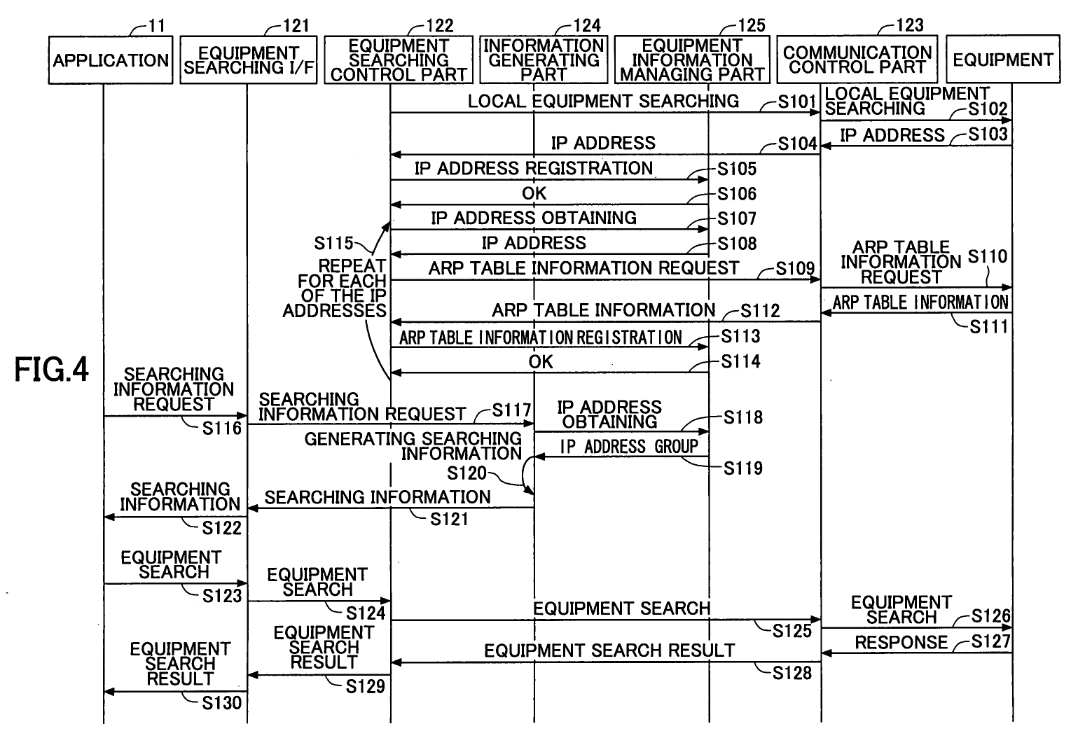

FIG. 4 is a sequence diagram for explaining process steps of an equipment searching process of a first embodiment of the present invention.

When the application 11 is started, the equipment searching module 12 is started so that an initial process is implemented. First, the equipment searching control part 122 searches for the equipment, including the router r1, connected to the own network n1, via the communication control part 123 (S101 through S104).

More specifically, the communication control part 123 issues the broadcast in a state where a sysObjectID of a system of MIBII is used as a keyword and the broadcast address (255.255.255.255) is used as address (S102). The broadcast is transmitted to the equipment items d12 through d15 connected to the own network n1 and the router r1.

The equipment items connected to the own network n1 and having the sysObjectID each responds with a response message including a value of the sysObjectID and the IP address of the equipment item to the equipment managing device 10 (S103).

The communication control part 123 receives the response messages from the equipment items so as to notify the equipment searching control part 122 (S104).

The equipment searching control part 122 requests the equipment information managing part 125 to register an IP address group based on the responses from the equipment items (S105). When the equipment information managing part 125 registers the IP address group in the secondary storage device 102, the equipment information managing part 125 responds to the equipment searching control part 122 whet the IP address group is registered in the secondary storage device 102 (S106).

Therefore, for example, all of the equipment items shown in FIG. 1 have the sysObjectID, and by implementing the processes of S101 through 106, a list of the IP addresses of the router r1 and the equipment items d11 through d15 connected to the own network n1 is recorded in the secondary storage device 102.

The reason why the broadcast is issued by using the sysObjectID as a keyword is for searching for the equipment where communication by SNMP can be performed.

Next, the equipment searching control part 122 obtains a single IP address stored in the secondary storage device 102 by the equipment information managing part 125 (S107, S108) and requests the equipment of the obtained IP address to send contents of an ARP (Address Resolution Protocol) table, namely ARP table information, held by the equipment or cached in the equipment, via the communication control part 123 (S109, S110).

Here, the ARP table correlates the IP address and the MAC address. In other words, it is general practice that the table correlating the MAC addresses and the IP addresses of equipment items which equipment items frequently communicate with each other is cached in each of the equipment items.

Accordingly, the equipment which is requested to send the ARP table information responds with the contents of the ARP table, namely the ARP table information, cached in the equipment, to the equipment managing device 10 (S111).

The communication control part 123 receives the ARP table information from the equipment and communicates it to the equipment searching control part 122 (S112).

The equipment searching control part 122 request the equipment information managing part 125 to register the ARP table information reported by the equipment (S113).

When the equipment information managing part 125 registers the IP address group in the secondary storage device 102, that fact that the IP address group is registered in the secondary storage device 102 is reported to the equipment searching control part 122 (S144).

In the MIBII, the IP address and the MAC address depending on the ARP table are managed as “atNetAddress” and “atPhysAddress”. Therefore, in a case where the ARP table information is obtained by the SNMP, values of “atPhysAddress” and “atNetAddress” should be obtained.

The steps of S107 through S114 are implemented for each of the IP addresses stored in the secondary storage device 102 by the process until S106 (S115).

At this time, the equipment searching control part 132 determines if the router r1 is connected to another router. If the router r1 is connected to another router, the ARP table information is obtained from this other router (router r2, for example).

In the case of the SNMP, by obtaining the value of “ipRouteNextHop” defined by the MIBII from the router r1, it is possible to obtain the IP address of the router r2. Therefore, based on the obtained IP address, the ARP table can be obtained from the router r2.

The steps of S107 through S114 are applied to the equipment items d11 through d15, the router r1, and the router r2 so that the ARP table information obtained from them is stored in the secondary storage device 102.

After these steps are finished the equipment searching module 12 is waiting for a request from the application 11.

When the application 11, automatically or based on input from the user, requests, via the equipment searching I/F 121, to provide a list (searching information) of address area information or a list of direct broadcast addresses in the equipment managing system (S116, S117), the information generating part 124 obtains the IP address group included in the ARP table stored in the secondary storage device 102 from the equipment information managing part 125 (S118, S119). The information generating part 124, based on the obtained IP address group, further generates the list of the address area information or the list of the direct broadcast addresses of each of the networks in the equipment managing system 1 (S120).

In generating the list of the address area information or the list of the direct broadcast addresses, the subnet address (or network address) is generated, based on the subnet mask, for each of the IP addresses included in the obtained ARP table information. The list of the subnet addresses of each of the networks n1, n2, and n3 shown in FIG. 1 is a result that excludes overlap of the generated subnet addresses.

In other words, not only the IP addresses of the equipment connected to the own network n1 but also the IP addresses of the equipment connected to the other network n2 are included in the ARP table information obtained from the router r1.

Furthermore, the IP addresses of the equipment connected to the other network n3 are also included in the ARP table information obtained from the router r2.

Accordingly, the subnet address generated based on these IP addresses includes ones for the other networks n2 and n3.

Furthermore, in order to generate the direct broadcast address, the IP addresses where all of the host address parts are 1 may be generated for the generated subnet address. A list of the IP addresses generated in this manner is a list of the direct broadcast addresses of the networks n1, n2, and n3.

For example, in a case where the IP address is “192.xxx.0.1” and the subnet mask is “255.255.255.0”, the higher order 24 bits are a network address part and the lower order 8 bits are a host part. Hence, a direct broadcast address generated based on the IP address is “192.xxx.0.255”.

In addition, in order to generate the address area information, an IP address of a minimum value of the host address and an IP address of a maximum value of the host address may be generated for every generated subnet address. A list of the area expressed by two IP addresses generated for the subnet address is a list of the address area information.

For example, in a case where the IP address is “192.xxx.0.1” and the subnet mask is “255.255.255.0”, the higher order 24 bits are a network address part and lower order 8 bits are a host part. Hence, a direct broadcast address generated based on the IP address is “192.xxx.0.1 through 192.xxx.0.255”.

Next, the information generating part 124 communicates the list of the direct broadcast addresses or the list of the address area information to the application 11 via the equipment searching I/F 121 (S121, S122).

The application 11, upon obtaining the list of the direct broadcast addresses or the list of the address area information, searches for the equipment based on the searching information by the subnet search or the area-designated search (S123 through S130).

In other words, if the direct broadcast address list is obtained, subnet search is implemented by issuing the direct broadcast for the direct broadcast address.

In addition, when the address area information is obtained, an inquiry is made to each of the IP addresses included in the address area information so as to implement the area-designated search based on existence of reaction to the inquiry.

Thus, it is possible to automatically search for not only the equipment connected to the own network n1 but also the equipment connected to the other network n2 or n3.

As discussed above, according to the equipment managing device 10 of the first embodiment of the present invention, it is possible to automatically generate the direct broadcast address for the subnet search or the address area information for area-designated search. Therefore, it is possible to search for the equipment on other network without making the user input this information.

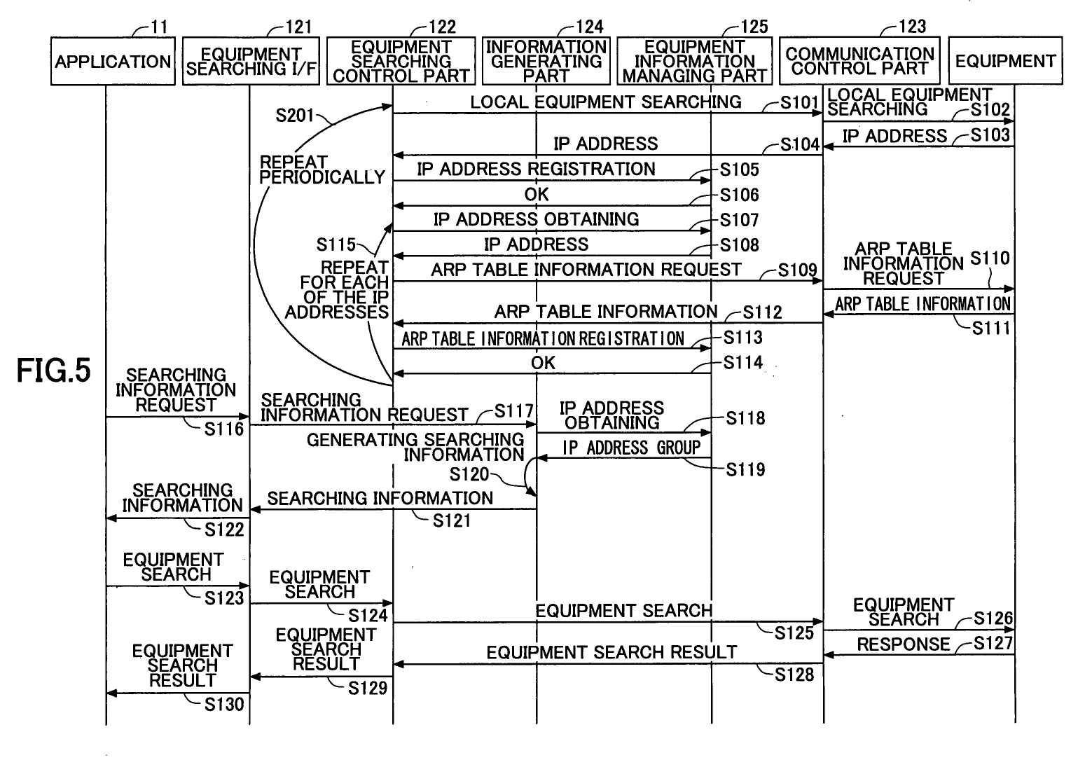

In the meantime, in the above-discussed first embodiment of the present invention, in a case where a structure of the network of the equipment managing system 1 is changed such that a new network is introduced, there may be trouble between the stored ARP table information and an actual network structure and therefore a searching result corresponding to the change may not be obtained. An example solving such a problem is discussed below as a second embodiment of the present invention with reference to FIG. 5.

FIG. 5 is a sequence diagram for explaining process steps of an equipment searching process of a second embodiment of the present invention. In FIG. 5, steps that are the same as the steps shown in FIG. 4 are given the same reference numerals, and explanation thereof is omitted.

In the example shown in FIG. 5, S201 is newly added compared to the example shown in FIG. 4. In other words, in the second embodiment of the present invention, the steps S101 through S115 are periodically and automatically implemented. Therefore, the ARP table information stored in the secondary storage device 102 is periodically renewed. In a renewing process, it is not necessary to complete exchange the contents stored in the secondary storage device 102. For example, only addition or deletion of newly added IP addresses or deleted IP addresses may be implemented.

As discussed above, according to the equipment managing device 10 of the second embodiment of the present invention, the ARP table information is periodically and automatically renewed. Therefore, even if the network structure is changed, it is possible to improve the likelihood that searching result corresponding to the change will be provided.

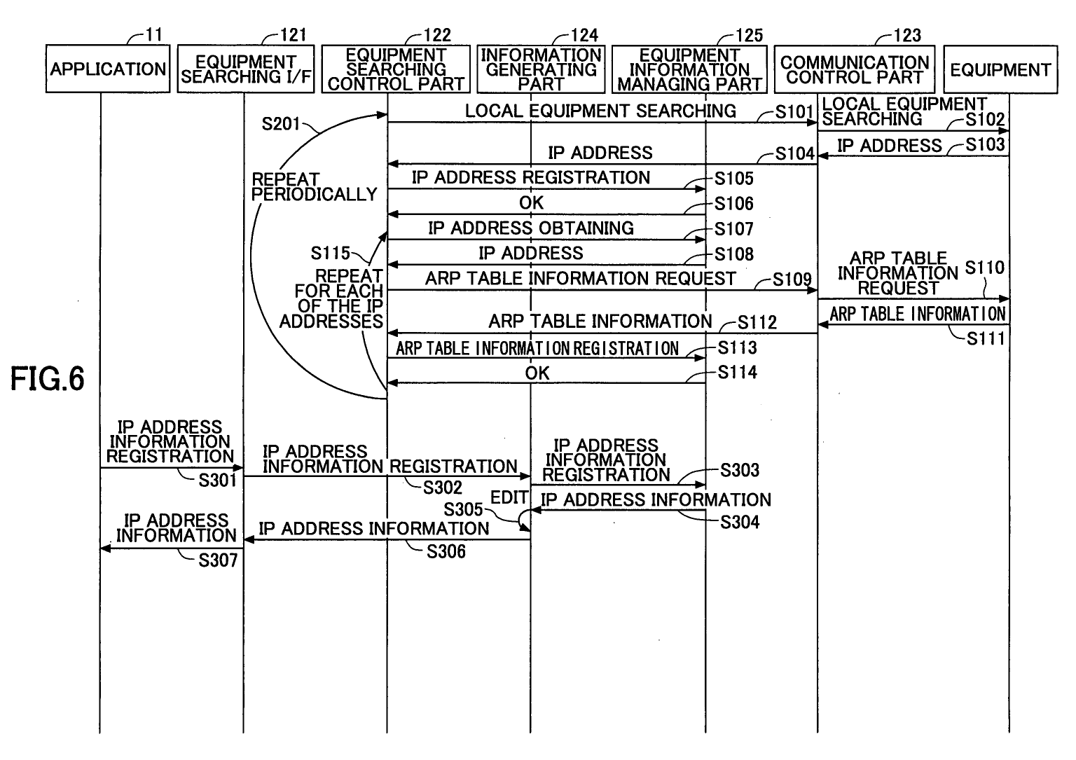

In the meantime, if the list of the IP addresses included in the ARP table stored in the secondary storage device 102 can be seen by the user, this is convenient. An example wherein such a function can be implemented is discussed as a third embodiment of the present invention with reference to FIG. 6.

FIG. 6 is a sequence diagram for explaining process steps of an equipment searching process of a third embodiment of the present invention. In FIG. 6, steps that are the same as the steps shown in FIG. 5 are given the same reference numerals, and explanation thereof is omitted.

In the example shown in FIG. 6, S301 through S307, instead of S116 through S130 of FIG. 5, are implemented.

For example, corresponding to input from the user, when the application 11 requests the list of the IP addresses via the equipment searching I/F 121 (S301, S302), the information generating part 124 obtains the IP address group included in the ARP table information stored in the secondary storage device 102 from the equipment information managing part 125 (S303, S304).

The information generating part 124 further edits the obtained IP address group (sorts or excluding overlapped IP addresses) (S305) and returns a list of edited IP addresses to the application 11 via the equipment searching I/F 121 (S306, S307). The application 11 makes the display part display the obtained list of the IP addresses by, for example, GUI so that the user can see the list.

As discussed above, according to the equipment managing device 10 of the third embodiment of the present invention, it is possible to easily provide the list of the IP addresses of the equipment connected to the network.

In the meantime, in the ARP table held (cached) in each of the equipment items, in a case where a certain time passes or access is not completely made to a certain IP address, entry of that IP address may be automatically deleted. Because of this, in the third embodiment of the present invention, since the list of the IP addresses is provided based on the ARP table, while the equipment exists on the network, the IP address of the equipment not accessed may not be included in the list. An example solving such a problem is discussed as a fourth embodiment of the present invention.

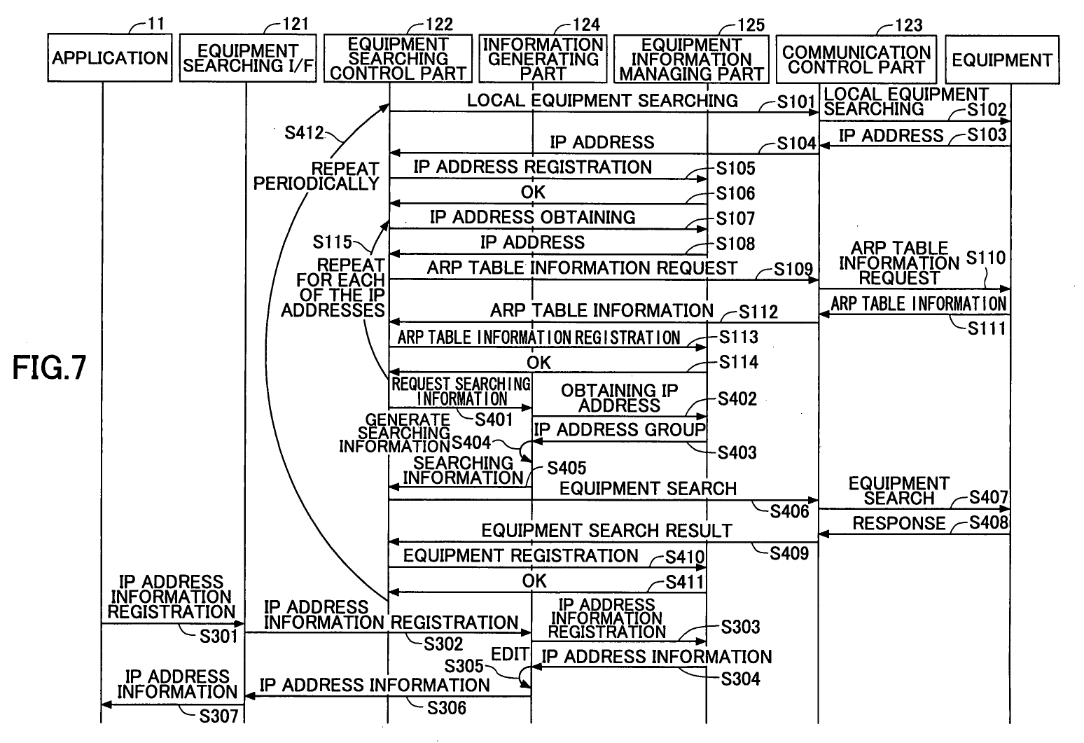

FIG. 7 is a sequence diagram for explaining process steps of an equipment searching process of a fourth embodiment of the present invention. In FIG. 7, steps that are the same as the steps shown in FIG. 6 are given the same reference numerals, and explanation thereof is omitted.

In the example shown in FIG. 7, S401 through S411 are newly added compared to the example shown in FIG. 6. In other words, when the ARP table information corrected from the equipment is registered (S114), the equipment searching control part 122 requests the information generating part 124 to provide the list of the address area information (searching information) or the list of the direct broadcast addresses of the equipment managing system 1 (S401).

The information generating part 124 obtains the IP address group included in the ARP table information stored in the secondary storage device 102 from the equipment information managing device 125 (S402, S403) so as to generate the list of the address area information or the list of the direct broadcast addresses of each of the networks of the equipment managing system 1 based on the obtained IP address group (S404). This generating process may be the same as the process of S120 shown in FIG. 4.

The information generating part 124 communicates the generated list of the address area information or the list of the direct broadcast addresses to the application 11 via the equipment searching I/F 121 (S405).

The equipment searching control part 122 obtaining the list of the address area information or the list of the direct broadcast addresses searches for the equipment by the subnet search or area-designated search based on the searching information (S406 through S409). This searching process may be the same as process after S123 shown in FIG. 4.

When the equipment searching control part 122 obtains the result of the search for the equipment (S409), the equipment searching control part 122 requests the equipment information managing part 125 to register the search results of the equipment (S410).

When the equipment information managing part 125 stores the search result in the secondary storage device 102, the equipment information managing part 125 reports that the search result is stored in the secondary storage device 102 to the equipment searching control part 122 (S411). The IP address of the equipment is included in the search result of the equipment.

In addition, in the example shown in FIG. 7, the steps of S101 through S411 are periodically implemented. Therefore, the search result of the equipment stored in the auxiliary device 102 is periodically renewed.

Next, the processes after S301 in FIG. 5 are implemented. However, the process implemented by the information generating part 124 is slightly different.

In other words, when the information generating part 124 receives a request of providing the IP address (S302), the information generating part 124 obtains the IP address group included in the search result of the equipment stored in the secondary storage device 102 from the equipment information managing part 125 (S303, S304).

The information generating part 124 further edits (sorts or excludes the overlapped IP address, for example) the obtained IP address group (S305) so as to communicate the list of the edited IP addresses to the application 11 via the equipment searching I/F 121 (S306, S307).

As discussed above, according to the equipment managing device 10 of the fourth embodiment of the present invention, the IP address of the equipment is provided based on not the ARP table information but the search result of the actual device. Therefore, it is possible to provide information (IP address) of the equipment connected to the network but not accessed at all from the periphery.

Thus, according to the above-discussed embodiment of the present invention, it is possible to provide an equipment managing device configured to manage equipment connected to a network, including: an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item; an address information generating part configured to generate address information of a network different from at least the equipment managing device, based on gathering the IP addresses obtained by the address obtaining part; and a searching part configured to search for equipment connecting to the network different from at least the equipment managing device, based on the address information generated by the address information generating part.

According to the above-discussed embodiment of the present invention, it is also possible to provide an equipment managing device configured to manage equipment connected to a network, including an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item; an address generating part configured to generate a subnet address of a network different from at least the equipment managing device, based on gathering the IP addresses obtained by the address obtaining part; and a searching part configured to search for equipment connecting to the network different from at least the equipment managing device, based on the subnet address generated by the address generating part.

More specifically, it is possible to provide an equipment managing device configured to manage equipment connected to a network, including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item; an address generating part configured to generate a subnet address of a network different from at least the equipment managing device,-based on gathering the IP addresses obtained by the second address obtaining part; and a searching part configured to search for equipment connecting to the network different from at least the equipment managing device, based on the subnet address generated by the address generating part.

The first address obtaining part and the second address obtaining part may periodically obtain the IP addresses. The searching part may issue a broadcast using a broadcast address of the subnet address based on the subnet address generated by the address generating part so as to search for the equipment connecting to the network different from at least the equipment managing device. The searching part may query each of IP addresses included in a range between a minimum value and a maximum value of the IP addresses of the subnet address based on the subnet address generated by the address generating part so as to search for the equipment connecting to the network different from at least the equipment managing device.

According to the above-discussed embodiment of the present invention, it is also possible to provide an equipment searching program configured to make a computer function as each of parts of an equipment managing device, the equipment managing device including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item; an address generating part configured to generate a subnet address of a network different from at least the equipment managing device, based on gathering the IP addresses obtained by the second address obtaining part; and a searching part configured to search for equipment connecting to the network different from at least the equipment managing device, based on the subnet address generated by the address generating part.

According to the above-discussed embodiment of the present invention, it is also possible to provide a computer readable recording medium including an equipment searching program, the equipment searching program being configured to make a computer function as each of parts of an equipment managing device, the equipment managing device including: a first address obtaining part configured to search for an equipment item connected to the same network as the equipment managing device so as to obtain an IP address of the equipment item; a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item; an address generating part configured to generate a subnet address of a network different from at least the equipment managing device, based on gathering the IP addresses obtained by the second address obtaining part; and a searching part configured to search for equipment connecting to the network different from at least the equipment managing device, based on the subnet address generated by the address generating part.

The present invention is not limited to these embodiments, but variations and modifications may be made without departing from the scope of the present invention.

This patent application is based on Japanese Priority Patent Application No. 2006-41016 filed on Feb. 17, 2006, the entire contents of which are hereby incorporated by reference.

What is claimed is:

1. An equipment managing device configured to manage equipment connected to a network, comprising:
an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item;
an address information generating part configured to generate address information of a network different from at least the equipment managing device, based on gathering the IP addresses obtained by the address obtaining part; and
a searching part configured to search for equipment connecting to the network different from at least the equipment managing device, based on the address information generated by the address information generating part.

2. An equipment managing device configured to manage equipment connected to a network, comprising:
an address obtaining part configured to search for an equipment item connected to the same network as the equipment managing device and configured to obtain an IP address of another equipment item from each of plural of the searched equipment items, the IP address of the other equipment item being held by the corresponding searched equipment item for communicating with the other equipment item;
an address generating part configured to generate a subnet address of a network different from at least the equipment managing device, based on gathering the IP addresses obtained by the address obtaining part; and
a searching part configured to search for equipment connecting to the network different from at least the equipment managing device, based on the subnet address generated by the address generating part.

3. An equipment managing device configured to manage equipment connected to a network, comprising:
a first address obtaining part configured to search for an equipment item connected to the same network as the equipment managing device so as to obtain an IP address of the equipment item;
a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item;
an address generating part configured to generate a subnet address of a network different from at least the equipment managing device, based on gathering the IP addresses obtained by the second address obtaining part; and
a searching part configured to search for equipment connecting to the network different from at least the equipment managing device, based on the subnet address generated by the address generating part.

4. The equipment managing device as claimed in claim 3,
wherein the first address obtaining part and the second address obtaining part periodically obtain the IP addresses.

5. The equipment managing device as claimed in claim 3,
wherein the searching part issues a broadcast using a broadcast address of the subnet address based on the subnet address generated by the address generating part so as to search for the equipment connecting to the network different from at least the equipment managing device.

6. The equipment managing device as claimed in claim 4,
wherein the searching part issues a broadcast using a broadcast address of the subnet address based on the subnet address generated by the address generating part so as to search for the equipment connecting to the network different from at least the equipment managing device.

7. The equipment managing device as claimed in claim 3,
wherein the searching part queries each of IP addresses included in a range between a minimum value and a maximum value of the IP addresses of the subnet address based on the subnet address generated by the address generating part so as to search for the equipment connecting to the network different from at least the equipment managing device.

8. The equipment managing device as claimed in claim 4,
wherein the searching part queries each of IP addresses included in a range between a minimum value and a maximum value of the IP addresses of the subnet address based on the subnet address generated by the address generating part so as to search for the equipment connecting to the network different from at least the equipment managing device.

9. An equipment searching program configured to make a computer function as each of parts of an equipment managing device, the equipment managing device comprising:
a first address obtaining part configured to search for an equipment item connected to the same network as the equipment managing device so as to obtain an IP address of the equipment item;
a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item;
an address generating part configured to generate a subnet address of a network different from at least the equipment managing device, based on gathering the IP addresses obtained by the second address obtaining part; and
a searching part configured to search for equipment connecting to the network different from at least the equipment managing device, based on the subnet address generated by the address generating part.

10. A computer readable recording medium including an equipment searching program, the equipment searching program being configured to make a computer function as each of parts of an equipment managing device, the equipment managing device comprising:
a first address obtaining part configured to search for an equipment item connected to the same network as the equipment managing device so as to obtain an IP address of the equipment item;
a second address obtaining part configured to obtain an IP address of another equipment item from each of plural of the equipment items searched for the first address obtaining part, the IP address of the other equipment item being held by the corresponding equipment item searched for by the first address obtaining part for communicating with the other equipment item;
an address generating part configured to generate a subnet address of a network different from at least the equipment managing device, based on gathering the IP addresses obtained by the second address obtaining part; and
a searching part configured to search for equipment connecting to the network different from at least the equipment managing device, based on the subnet address generated by the address generating part.
